(19) United States
(12) Patent Application Publication
(10) Pub. No.: US 2002/0080251 A1
(43) Pub. Date: Jun. 27, 2002

(54) Digital imaging device, image processing device, digital imaging method, and image processing program

(75) Inventor: Kagumi Moriwaki, Itami-Shi (JP)

Correspondence Address: MCDERMOTT, WILL & EMERY, 600 13th Street N.W., Washington, DC, 20005-3096, US

(73) Assignee: MINOLTA CO., LTD.

(21) Appl. No.: 09/727,537

(22) Filed: Dec. 4, 2000

(30) Foreign Application Priority Data
Dec. 9, 1999 (JP) 11-350127

(51) Int. Cl. H04N 5/76

(52) U.S. Cl. 348/232; 348/333.03

(57) ABSTRACT

During photography using a digital camera, a monitor image and a frame image representing an ideal region of a main object are superimposed and displayed on a display unit. FIG. 6A shows a single person as a main object, with a frame F1 superimposed on a monitor image of the object. When this object is photographed and the image data are saved to a memory card, “large-single-person” as an object name, and two angle coordinates (x11,y11) and (x12, y12) of frame F1 as object region coordinates are associated with the image data and recorded. Thereafter, when the image data are read from the memory card and subjected to image correction, the associated and recorded object name and object region coordinates are referenced to set special correction parameters for the object region in order to accomplish image correction.

This application is based on application No. 11-350127 filed in Japan, the content of which is hereby incorporated by reference.

### BACKGROUND OF THE INVENTION

1. Field of the Invention

The present invention relates to a digital imaging device for obtaining photographic image data as digital data of a photographic image including a photographic object, and an image processing system, image processing device, digital imaging method, and recording medium using same.

2. Description of the Related Art

In recent years many cameras provided with image correction have been proposed, and among those is art disclosed in Japanese Laid-Open Patent No. HEI 11-136568 pertaining to a camera wherein photographed image data are stored as a specific memory object, and thereafter the stored photographic image data are subjected to various types of image correction processing during later printing or regeneration. In this art, a user specifies a main photographic subject during photography, and based on this information, image data obtained by autofocus and automatic exposure are stored either in an internal memory or an external memory. At this time, the position information of the main subject input by the photographer via a touch panel is also stored together with the image data, and this position information of the main subject is later used during printing or regeneration for correcting brightness at the margins of the main subject as well as image quality correction.

In the conventional art, however, the type of main subject, e.g., photographic subject such as a person, animal or scenery, is undifferentiated, and input of subject information by the photographer is required later when performing image processing such as image correction and the like.

Furthermore, an input means such as an input screen or the like is required for the aforesaid input when the photographic subject is subjected to subsequent image correction and the like, thereby increasing manufacturing cost.

### SUMMARY OF THE INVENTION

An object of the present invention is to provide resolve the disadvantages of the conventional art by providing an inexpensive digital imaging device readily capable of image processing of image data read after being recorded, and an image processing system, image processing device digital imaging method and recording medium provided with same.

These objects are attained by the present invention. According to one aspect of the present invention, a digital imaging device for obtaining image data as digital data of a photographic image including an object, comprises: a memory for storing image data of a plurality of frames representing an ideal region of an object within an image, each frames corresponding to types of object; a frame selector for selecting a frame from the plurality of frames as a selected frame; a display device for displaying the selected frame superimposed on a monitor image obtained by an image sensing device; an image capture device for capturing a image data based on the monitor image; and a recording device for recording an information, comprising a type of the object corresponding to the selected frame and data representing an object area corresponding to the selected frame, and the image data captured by the image capture device on a recording medium being associated each other.

According to another aspect of the present invention, an image processing device for image processing of an image data including an photographic object, comprising a reading device for reading the image data and an information having a kind of an object in the image data and an object area data in which the object is arranged within the image data; and a photographic image corrector for correcting the image data based on the information.

According to another aspect of the present invention, an image processing device for image processing of an image data including a photographic object, a template memory for storing a template which is a previously prepared image data; a reading device for reading the image data and an information having a kind of an object in the image data and an object area data in which the object is arranged within the image data; and a template combining means for combining the template from the template memory with the image gate based on the information.

### BRIEF DESCRIPTION OF THE DRAWINGS

These and other objects and features of this invention will become clear from the following description, taken in conjunction with the preferred embodiments with reference to the accompanied drawings in which:

FIG. 1 is perspective view showing the front exterior structure of a digital camera 1A (1B) of an embodiment of the invention;

FIG. 2 is perspective view showing the back exterior structure of a digital camera 1A (1B) of an embodiment of the invention;

FIG. 3 is a block diagram showing the functional structure of the digital camera 1A (1B) of an embodiment of the present invention;

FIG. 4 is a flow chart showing the CPU controls and operation of the digital camera during photography;

FIG. 5 shows the condition of the frame selection input screen by key word;

FIGS. 6A and 6B show examples of frames;

FIG. 7 shows an example of a frame;

FIG. 8 is a flow chart showing the image correction process sequence;

FIG. 9 shows the memory state of the image file and the specific information file;

FIG. 10 is a flow chart showing the processing sequence during image correction processing after shooting;

FIGS. 11A and 11B show examples of templates;

FIG. 12 is a flow chart showing the template combining process sequence; and

FIG. 13 is a block diagram showing the structure of an image processing system of a second embodiment.

### DETAILED DESCRIPTION OF THE PREFERRED EMBODIMENTS

The embodiments of the present invention are described hereinafter with reference to the accompanying drawings.

1. First Embodiment

1-1. Overall Structure

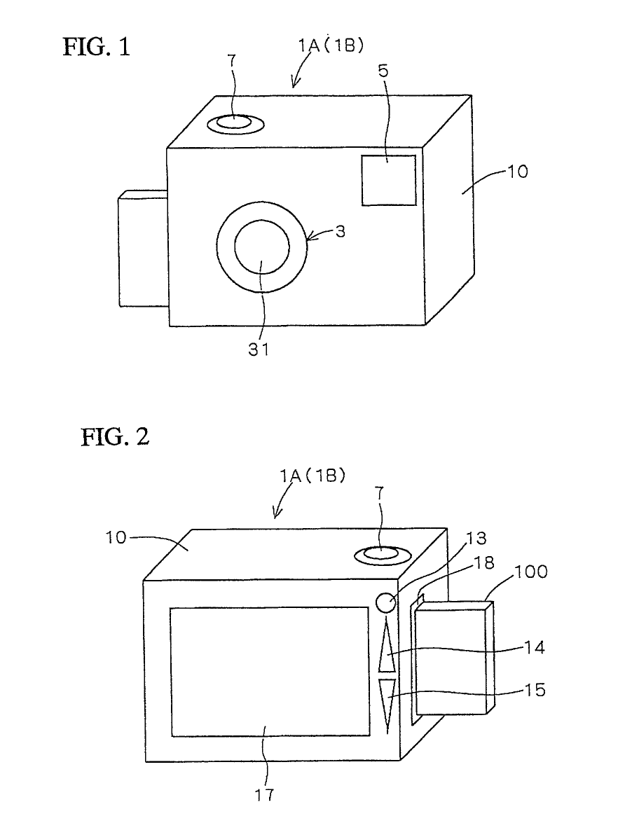

FIGS. 1 and 2 are perspective views showing the exterior structure of digital cameras 1A (1B) of an embodiment of the present invention. FIG. 1 is a perspective view from the front side, and FIG. 2 is a perspective view from the back side. The overall structure of the digital camera 1A (1B) is described below with reference to FIGS. 1 and 2.

The digital camera 1A (1B) broadly comprises an image sensing unit 3, and camera body 10 having an approximately rectangular shape.

The image sensing unit 3 is provided with a taking lens 31, image forming optical system (not shown), and solid state image sensing element (not shown) such as CCD or CMOS sensor, wherein light impinging the taking lens 31 forms an image on the solid state image sensing element via the image forming optical system, and photographic image data are obtained as digital data.

A flash 5 for illuminating an object is provided on the top at the front of the camera body 10, and its emission is controlled by a CPU. A release button 7 is provided on the top of the camera body 10.

The release button 7 is an operating member which sets a photography preparation state when half depressed, and executes a shutter release when fully depressed.

A memory card insertion slot 18 is provided on one side of the camera body 10. The memory card insertion slot 18 is a slot-shaped insertion port which allows the loading of an external recording medium (hereinafter referred to as “memory card”) within the camera body 10, and is internally provided with a memory card interface (I/F) described later.

On the back side of the camera body 10 are provided a confirm button 13, scroll buttons 14 and 15, and display 17.

The display 17 comprises, for example, an LCD or the like, and displays the superimposed frame image described later and monitor image of a photographic candidate image obtained through the image sensing unit 3 during shooting, displays photographed image data recorded on the memory card (described later), and displays the selection-setting screens for selecting and setting items (including key words described later) of various types.

The scroll buttons 14 and 15 are buttons for optional selection by a user from among a plurality of items when the selection-setting screens are displayed; wherein the items are scrolled forward (UP) each time scroll button 14 is pressed, and reverse scrolled (DOWN) each time scroll button 15 is pressed. The scroll buttons 14 and 15 are access buttons for calling up the captured image data recorded on the memory card 100 when regenerating previously captured image data, wherein the recorded images are scrolled forward (UP) each time scroll button 14 is pressed, and reverse scrolled (DOWN) each time scroll button 15 is pressed.

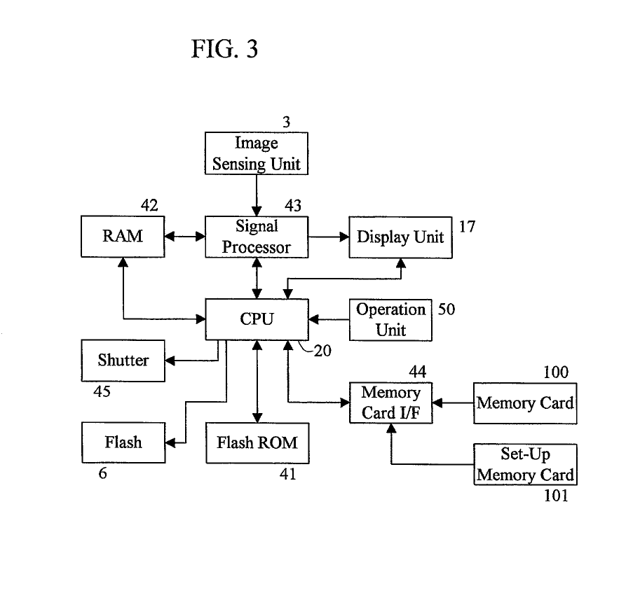

FIG. 3 is a block diagram showing the functional structure of the digital camera 1A (1B) of the embodiment.

The digital camera 1A (1B) is provided with a CPU 20 as a system controller for controlling the operation of the entire digital camera. The CPU 20 realizes the various functions described below by reading out and storing control programs installed in flash ROM 41 to the RAM 42, and executing these programs during operation.

The captured image data obtained by the image sensing unit 3 are temporarily stored in the RAM 42, displayed on the display unit 17, and subjected to image correction processing and template combination processing in the signal processor 43 based on controls by the CPU 20. The memory card 100 is a removably installable recording medium capable of recording a plurality of photographic image data and comprises, for example, RAM; data can be transferred between the memory card 100 and the CPU 20 through the memory card interface (I/F) 44 provides within the memory card insertion slot 18. In this way during shooting, the image data subjected to image correction processing in the signal processor 43 and are recorded on the memory card 100 via the memory card I/F 44 based on the control of the CPU 20. Conversely, image data recorded on the memory card 100 can be read by the CPU 20 and displayed on the display unit 17.

The signals produced by the operation unit 50 including the release button 7, confirm button 13, and scroll buttons 14 and 15 are transmitted to the CPU 20, and the CPU 20 confirms each operation by the user. When the release button 7 is fully depressed, the CPU 20 controls the release of the shutter 45.

The controls programs of the CPU 20 can be updated using a set-up memory card 101 equivalent to the recording medium as necessary for functional enhancement. Specifically, an update program for updating the previously installed control program, and an updated control program to be installed after installation of a control program previously installed in flash ROM 41 are recorded on set-up memory card 101, such that when this set-up memory card 101 is loaded in the memory card insertion slot 18, these control programs and update programs are read from the inserted memory card 101 and installed

1-2. Operation and Processing

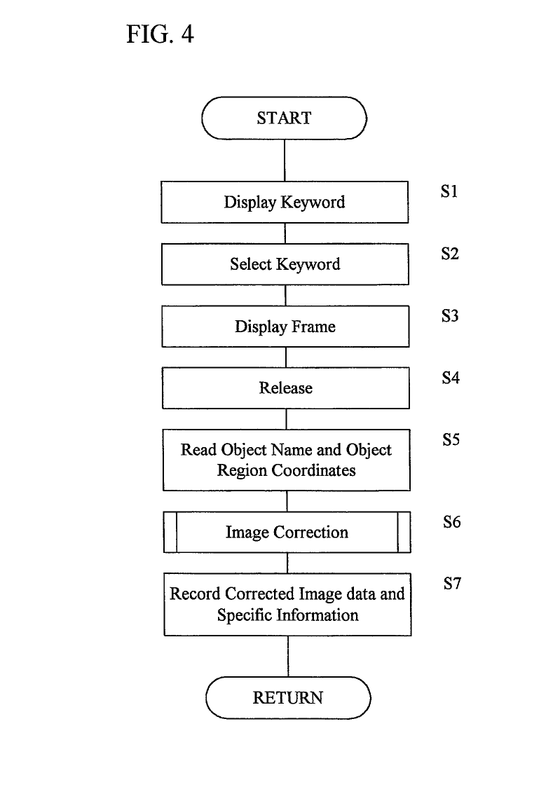

FIG. 4 is a flow chart showing the control by the CPU 20 and operation of the digital camera 1A during shooting. The operation of the digital camera 1A and the control by the CPU 20 are described below with reference to FIG. 4. The control of the processes below are executed by the CPU 20 unless otherwise specified.

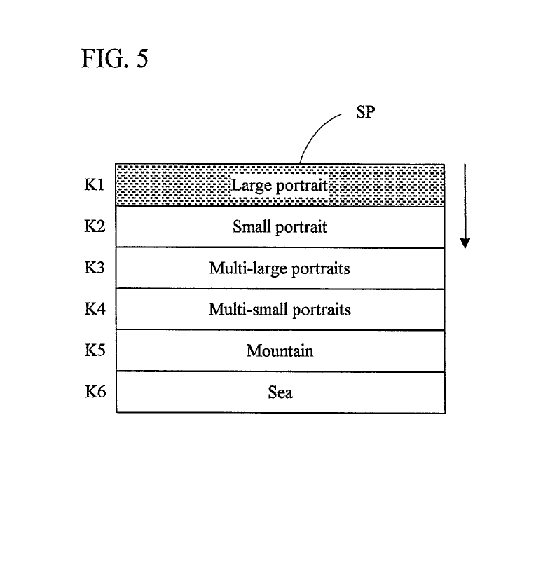

First, a key word list is displayed on the display unit 17 (FIG. 4, step S1). FIG. 5 shows the condition of the key word frame selection input screen SP. In digital camera 1A of the present embodiment, a frame image representing an ideal region containing a main object within a photographic range and a monitor image are superimposed and displayed on the display unit 17 as the user suitably composes a main object during shooting, such that the user can take readily a picture when the main object is suitably composed. First, in step S1, a list of key words corresponding to each frame is displayed on the display unit 17 to allow a user to select a frame. In FIG. 5, six key words are displayed as selection items, i.e., large portrait K1, small portrait K2, multiple large portraits K3, multiple small portraits K4, mountain K5, sea K6.

TABLE 1

| Key word | Object | Region coordinates |
|---|---|---|
| Large portrait | Lg-single-person | (x11,y11),(x12,y12) |
| Small portrait | Sm-single-person | (x21,y21),(x22,y22) |
| Multi-large portraits | Lg-multi-persons | (x31,y31),(x32,y32) |
| Multi-small portraits | Sm-Multi-persons | (x41,y41),(x42,y42) |
| Mountain | Mountain | (x51,y51),(x52,y52) |
| Sea | Sea | (x61,y61),(x62,y62) |

Table 1 shows the main object and object region coordinates corresponding to the key word. As shown in Table 1, the main object names corresponding to large portrait K1 and small portrait K2 are large-single-person and small-single-person, respectively, and the frames corresponding to these names are frames for large and small photographs of a single person. The main object names corresponding to large-multiple portraits K3 and small-multiple portraits K4 are large-multi-persons and small-multi-persons, respectively, and the frames corresponding to these names are frames for large and small photographs of a multiple persons. The main object names corresponding to mountain K5 and sea K6 are mountain and sea, and the frames corresponding to these names are frames photographing landscapes of mountain and sea.

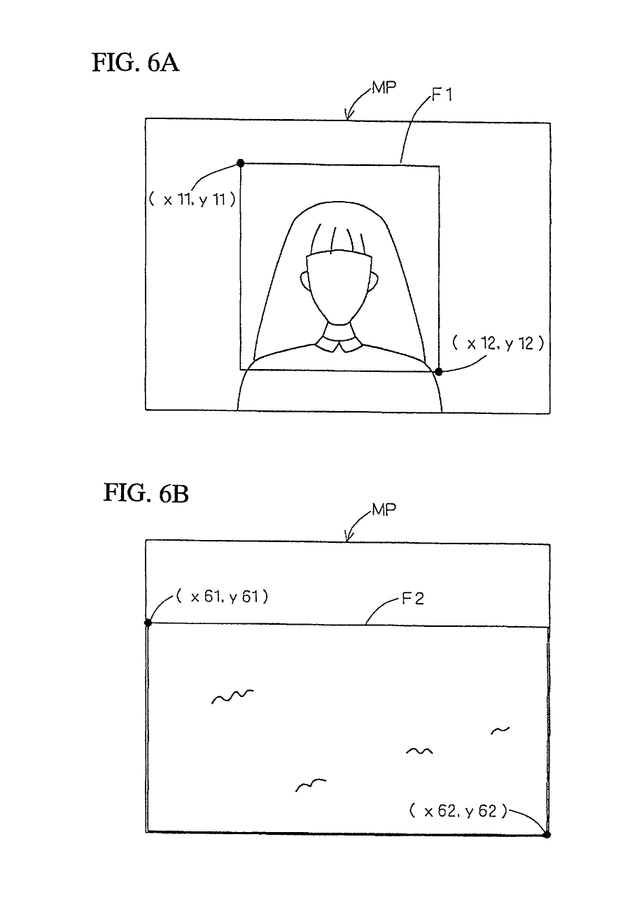

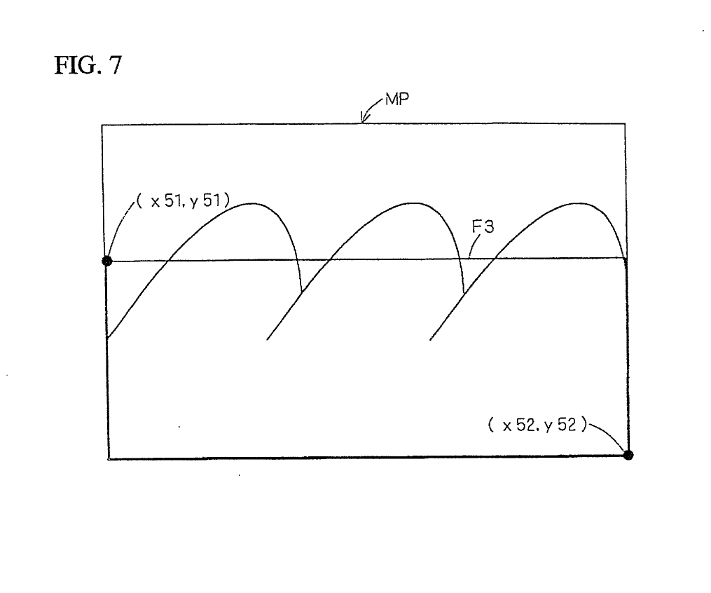

FIGS. 6A and 6B, and FIG. 7 show examples of frames; FIG. 6A shows a frame of a “large-single person,” FIG. 6B shows a frame of “sea,” and FIG. 7 shows a frame of “mountain.” During shooting, a monitor image MP is displayed on the display unit 17 showing the superimposed monitor image and frame as previously mentioned, and a user takes a picture of the object as to be within the frame while viewing the monitor image MP. Specifically, the face of a single person is within the square frame Fl with regard to the photographic object name of large-single-person as shown in FIG. 6A; the entire body of a single person is within the vertical rectangular frame with regard to small-single person (not illustrated); the upper half body of a multiple persons is within the horizontal rectangular frame with regard to large-multi-persons (not illustrated); the entire body of a multiple persons is within the horizontal rectangular frame with regard to small-multi-persons (not illustrated); the sea below the horizon line is within the rectangular frame F2 with regard to sea as in FIG. 6B; and the mod to lower mountain side is within the rectangular frame F3 with regard to mountain as shown in FIG. 7.

The object region coordinates are coordinate values for specifying the region in a frame, i.e., an ideal region including the object. When points (corresponding to each pixel of the display unit 17) in the monitor image are represented by coordinates (x,y), the upper left and lower light coordinates in FIGS. 6A, 6B, and 7 are represented as (xi1,yi1), (xi2,yi2), where i (=1˜6) is a number representing the frame. The frame size and position within the object image can be completely specified by these coordinate values.

Then, a user selects and sets a key word from among the key words displayed on the display unit 17 (FIG. 4, step S2). Specifically, as shown in FIG. 5, one among the plurality of key words displayed on the display unit 17 reverse displayed, and this reverse display is moved vertically (UP, DOWN) by the scroll buttons 14 and 15. The user selects and sets a frame corresponding to a key word by pressing the confirm button when a desired key word is reverse displayed.

Next, the frame is superimposed on the monitor image on the display unit 17 (FIG. 4, step S3). The display on the display unit 17 at this time is shown in FIGS. 6A, 6B, and 7, showing the frame image superimpose on the monitor image.

Next, when the user presses the release button 7, the CPU 20 releases the shutter 45 (FIG. 4, step S4).

Then, Then, the CPU 20 reads the object name and object region coordinates corresponding to the selected frame from the frame table stored in flash ROM 41 (FIG. 4, step S5). The frame table is shown in Table 1, and is a table associates and stores the object name and object region coordinates corresponding to each frame.

The CPU 20 then controls the signal processor 43 according to the user instruction, and executes the image correction process with regard to the image data (FIG. 4, step S6).

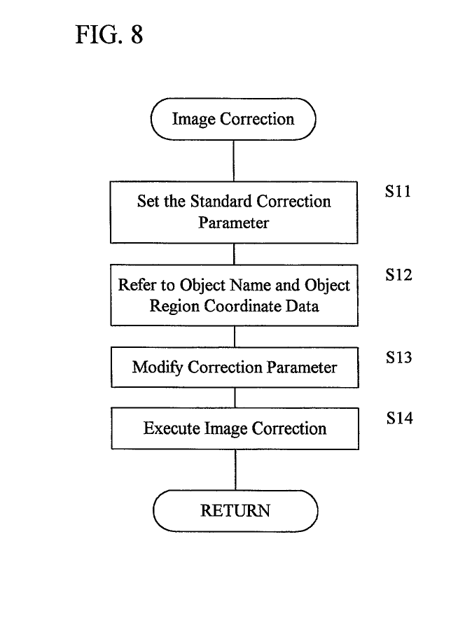

The image correction process is described below. FIG. 8 is a flow chart showing the image correction process sequence.

First, CPU 20 reads and sets the standard correction parameter from the flash ROM 41 (FIG. 8, step S11). Specifically, regardless of the image content (photographic object), the correction parameter previously stored in flash ROM 41 and standardly used for the entire image is read to RAM 42, and stored at a specific address. The correction parameter are data specifying process content for image correction including sharpness process, modification and adjustment of contrast and chroma and the like.

Then, CPU 20 refers to the object name and the object region coordinate data corresponding to the selected frame stored in RAM 42 (FIG. 8, step S12).

Next, with regard to within the object region, CPU 20 modifies the correction parameter corresponding to the main object (FIG. 8, step S13). Specifically, the CPU 20 reads the correction parameter corresponding to the main object of the selected frame from the collection of correction parameters corresponding to each object name stored in flash ROM 41, and modifies the standard correction parameter previously set in RAM 42 only for the object region to the read correction parameter. Regions other than the object region stored in RAM 42 are not modified from the standard correction parameter.

TABLE 2

| Object name | Correction parameter |
|---|---|
| Lg-single person, Lg-multi-person | Sharpness: NO |
| | Contrast: weak |
| Sm-single person, Sm-multi-person | Sharpness: Very weak |
| | Contrast: weak |
| Mountain | Chroma: large increase |
| Sea | Chroma: large increase |

Table 2 is a table showing an example of a collection of correction parameters. In the collection of correction parameters of Table 2, sharpness image correction is not performed, and correction is weakened for images having the object names of large-single-person and large-multi-person images; chroma is largely increased for images of mountains; and chroma is largely increased for images of the sea. The correction parameters given in Table 2 are expressed in the words “weak,” “strong,” and “increase,” but actually sharpness, contrast, and chroma are recorded as data representing numeric values in a specific range. This collection of correction parameters is only an example, and each correction parameter is optional.

After setting the correction parameter, the signal processor 43 executes image correction in accordance with the set correction parameter (FIG. 8, step S14).

This completes the image correction process.

Referring now to FIG. 4, the CPU 20 then associates and records the photographic image data after image correction in step S6 and the specific information file obtained in step S5 to the memory card 100 (FIG. 4, step S7).

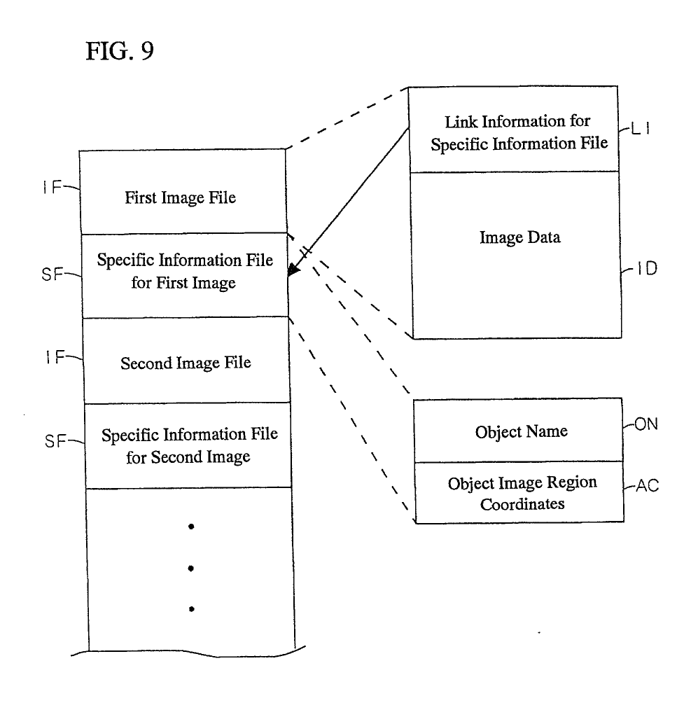

FIG. 9 shows the recording state of the image file IF and the specific information file SF. As shown in FIG. 9, the image file IF including the image data ID, and the specific information file SF comprising the image name ON and object image region coordinates AC regarding the image data are mutually associated and stored in the memory card 100. Specifically, the image file IF includes, other than the image data ID, the link information LI such as the address at which is recorded the specific information file SF corresponding to the image data. A specific image file IF and the corresponding specific information file SF can be easily read from the memory card 100 storing a plurality of image data ID by referring to the link information LI.

Image sensing and sensed image data are stored in the memory card 100 in the aforesaid sequence, and a plurality of image data can be stored by repeating this sequence, and the respective specific information files can be associated and stored on the memory card 100.

Although this completes the description of the operation and processes of the digital camera 1A during shooting, the digital camera 1A in this example can read image data stored on the memory card 100 after shooting, and again perform image correction processing and template combination processing. These processes are described below.

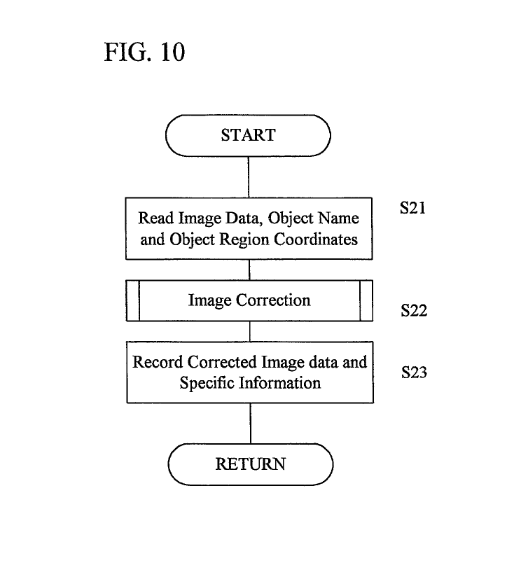

First, image processing is described. FIG. 10 is a flow chart showing a sequence of the image correction processing.

First, the CPU 20 reads the image data and image name and object region coordinates from the image file stored in the memory card 100 and the appended specific information file to the RAM 42 (FIG. 10, step S21).

Then, image data specified by the user is subjected to image correction (FIG. 10, step S22). This process is nearly identical to the process of step S6 of FIG. 4. That is, the signal processor 43 performs the image correction process of FIG. 8 based on the control by the CPU 20. The object name and object region coordinates used at this time within the image file of the object and the specific information file stored with the link on the memory card 100, and the more detailed image correction only differs from step S6 of FIG. 8 using the different correction parameter of reach extracted region being a part of the object.

TABLE 3

| Object name | Extracted region | Correction parameter |
|---|---|---|
| Lg-single-person, | Skin tone within region | Sharpness: NO |
| Lg-multi-persons | | Contrast: weak |
| | Mouth within region | Chroma: large increase |
| | Eye within region | Sharpness: weak |
| Sm-single-person, | Skin tone within region | Sharpness: very weak |
| Sm-multi-persons | | Contrast: weak |
| Mountain | Green within region | Chroma: large increase |
| Sea | Blue within region | Chroma: large increase |

Table 3 shows an example of a collection of correction parameters of each extracted region. As shown in Table 3, a special correction parameter is set for a small part of the object. Specifically, when the object is a large-single-person and large-multi-persons, a correction parameter is set to weaken contrast without sharpness processing is set for areas of human skin tone within the object region, a correction parameter is set to largely increase chroma in red areas of the human mouth, and a correction parameter is set to strengthen sharpness in areas of human eyes. When the object image is small-single-person and small-multi-persons, a correction parameter is set to increase the chroma of areas of human skin within the object region; when the object region is mountain, a correction parameter is set to increase chroma for areas of green color in the object region; when the object region is sea, a correction parameter is set to increase chroma for areas of blue color in the object region.

Different image correction is performed for each extracted area using these correction parameters. The extraction of each extraction region is accomplished using well known methods for discriminating whether or not the color difference or hue is within a specific range for extraction with the exception of areas of the eyes for large-single-person and large-multi-persons, and this automatic extract is performed by the digital camera 1A. That is, the color components of each characteristics area of each pixel in the object region is read, and if color component is within the range of the specific color difference or hue, the pixel is included in the extraction region, otherwise the pixel is not included in the extraction region. The area of the eye of large-single-person and large-multi-persons is extracted by the following method. An image of an average eye is provided beforehand in the flash ROM 41 of the digital camera 1A, and pattern matching with this average eye image is used for extraction in the vicinity of the approximate position of an eye in the recorded image determined by the relative positional relationship with the mouth extracted in the separate process described above. This pattern matching may be achieved using a well known method.

Finally, the CPU 20 links the image file including the corrected image data obtained in step S22 with the specific information file similarly to the image file including the image data, and writes the files to the memory card 100 (FIG. 10, step S23). The image correction process after image recording then ends.

The template combination process is described below. The digital camera 1A of the present embodiment can combine template images being specific images on the peripheral areas of an image relative to a captured image.

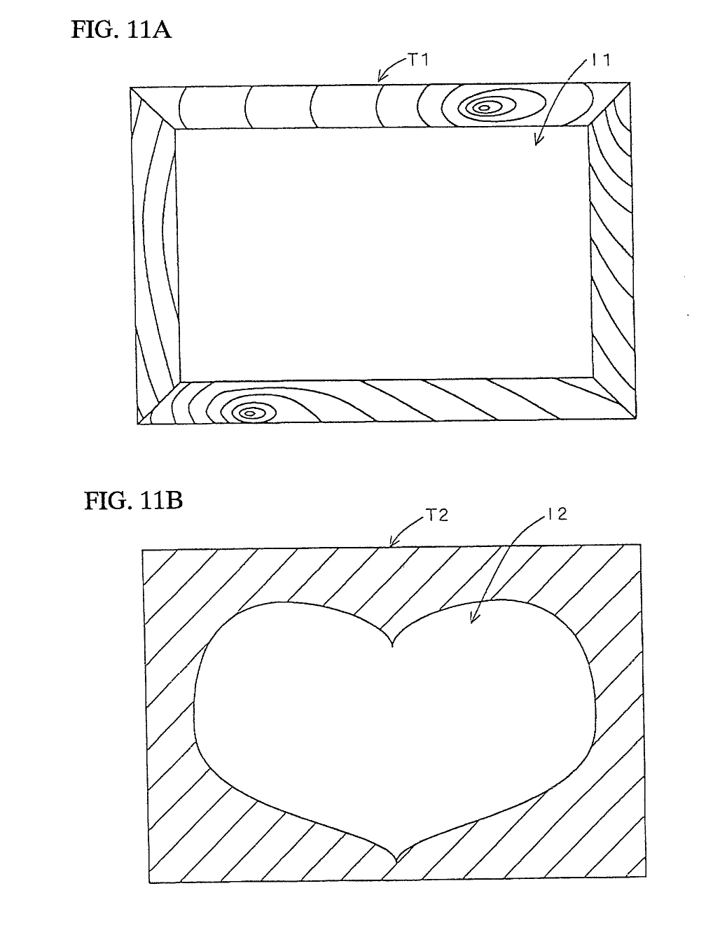

FIGS. 11A and 11B show examples of a template. FIG. 11A shows a photo frame template T1, and FIG. 11B shows a heart-shaped template T2. In FIGS. 11A and 11B, the image within the object region in the read image are inlaid in the inlay region 11 and inlay region 12 by the combination process.

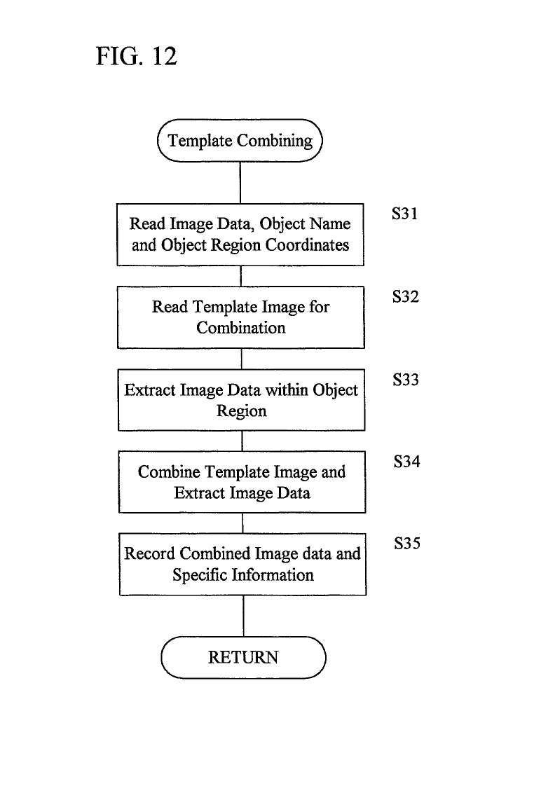

FIG. 12 is a flow chart showing the sequence of the template combining process.

First, the CPU 20 reads the object name and object region coordinates includes in the specific information file and image file selected from the memory card 100 (FIG. 12, step S31). Specifically, a user operates the scroll buttons 14 and 15 and the confirm button 13 to select image data in a selection screen display (not illustrated) displayed on the display unit 17, or more detailed, in a screen displaying a list of image data recorded on the memory card 100. Then, an image file including the selected image data and the corresponding specific information file are read from among the image files stored on the memory card 100, and the image data, object name, and object region coordinates are stored in RAM 42.

Then, CPU 20 reads the combination candidate template image selected from the flash ROM 41 (FIG. 12, step S32). Specifically, a user operates the scroll buttons 14 and 15 and the confirm button 13 to select image data in a selection screen display (not illustrated) displayed on the display unit 17, or more detailed, in a screen displaying a list of image data recorded on the memory card 100. the image data of a template selected from among a plurality of templates stored in the flash ROM 42 are recorded on the RAM 42.

Next, the signal processor 43 extracts the image data within the corresponding object region from the read image data based on the control of the CPU 20 (FIG. 12, step S33).

Then the image data of the object region extracted by the signal processor 43 are combined with the template image (FIG. 12, step S34). Specifically, the CPU 20 reads the contour information, i.e., vector data specifying the contour of the inlay region in the combination candidate template image, and transmits this information to the signal processor 43. Then, the signal processor 43 adapts this contour within the object region of the selected image data, and the image data within this contour are extracted as extraction image data. Then, the image processor 43 obtains the image data combined with the template image by inserting the extracted image data in the inlay region of the combination candidate template image data transmitted from the CPU 20.

Finally, the CPU 20 writes the image file including the combined image data and the linked specific information file similar to the image file obtained by shooting to the memory card 100 (FIG. 12, step S35).

The template image combination process then ends, but this process may be repeated as necessary.

According to the first embodiment described above, a frame is selected from among a plurality of frames as a selection frame, the selected frame and a monitor image are superimposed and displayed, image data corresponding to the monitor image are obtained, and a specific information file being a file of information for specifying an object type and object region corresponding to the selected frame is linked to an image file including the captured image data as a specific recording object recorded on the memory card 100, such that image processing can be performed by a simple operation of specifying the main object and object region in the image data by reading the image file and the linked specific information file.

Since a special designation means for specifying a main object and object region is not required and operation is simplified by not requiring the specification of the main object and object region separately from the frame selection by the user, manufacturing costs are controlled and an inexpensive device can be realized.

Since frame selection is accomplished by selecting a key word from among key words corresponding to a plurality of frames in a frame selection screen used as a frame selection means, a plurality of frames can be easily managed by key words, thereby allowing a desired frame to be easily selected.

Furthermore, since a specific information file including object name and object region coordinates and an image file including image data are mutually associated and recorded in memory card 100, when subjecting previously recorded image data to image processing, the image data can be read without the user specifying the object name and object region corresponding to the image data, thereby simplifying the operation.

In addition, since the image correction of the image data is accomplished while referencing the specific information file, image correction of the object region can be accomplished without the user specifying the object or object region within the image data, thereby allowing image correction by a simple operation.

Furthermore, since the template is read and combined with the image data while referencing the specific information file, template combination is accomplished without the user specifying the object or object region within the image data, thereby allowing template combination by a simple operation.

2. Second Embodiment

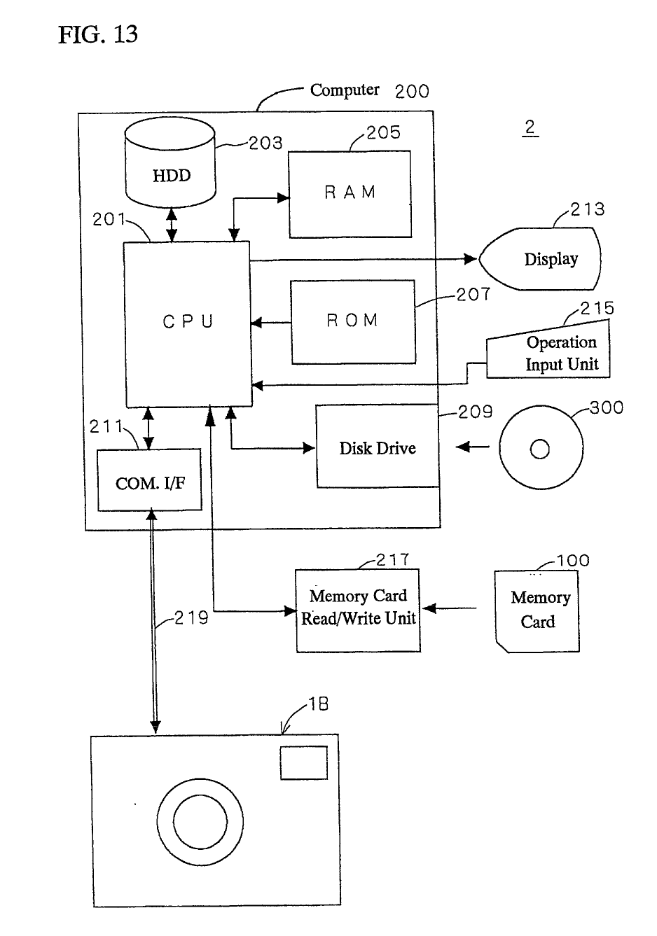

FIG. 13 is a block diagram showing the structure of an image processing system of a second embodiment. The system of the second embodiment is provided with a digital camera 1B nearly identical to that of the first embodiment, and a personal computer (hereinafter referred to as “computer 200”).

The computer 200 in the image processing system is provided with an internal CPU 201, hard disk 203, RAM 205, ROM 207, a disk drive 209 capable of reading/writing to a floppy disk, CD-ROM, CD-R or the like, an a communication interface (I/F) 211 such as a serial port or USB port or the like, and is further provided with peripheral devices including a display 213, operation input unit 215 such as a keyboard and mouse and the like, an a memory card read/write unit 217 for reading and writing to a memory card 100.

The control programs of each process below performed by the CPU in the computer 200 can be installed and updated for functional enhancement using a set-up disk 300 such as a CD-ROM, magnetic disk or the like as a recording medium. Specifically, recorded on the set-up disk 300 are a control program for initial installation, control program for updating the installation the control program previously installed on the hard disk has been installed, and update program for updating the previously installed program, and these control programs and update programs are read from the set-up disk 300 for installation.

A socket (not illustrated) is provided on the digital camera 1B in the image processing system 2, such that a communication cable 219 connected to the communication I/F 211 of the computer 200 is connected to this socket to allow transmission/reception of data such as image files and specific information files.

The processes performed in the digital camera 1B in the image processing system 2 of the present embodiment are nearly identical to the processes shown in FIG. 4. In the digital camera 1B, the captured image data recorded on the memory card 100 cannot be subjected to image correction processing or template combination processing. Rather, the image correction processing and template combination processing is accomplished by the computer 200. Specifically, the image file and the specific information file linked to the image file recorded on the memory card 100 by the digital camera 1B similar to the first embodiment can be read from the digital camera 1B by installing the memory card 100 in the memory card read/write unit 217 via the communication cable 219. In this way image correction processing and image combination processing can be accomplished similar to the flow charts of FIG. 10 and FIG. 12 of the first embodiment using the read image data and object name and object region coordinates corresponding to the image data. Since the image data read by the computer 200 are the image data captured by the digital camera 1B, the image data of the object are naturally included in the object region in the image data.

Points of departure include the manual modification of the correction parameter corresponding to the object region in the image correction process in the computer, and the provision of a mode for manual extraction of an extraction region. Specifically, in the correction parameter setting screen, the entire read photographic image is displayed on the display 213, and the area for which the correction parameter is to be modified is specified by the operation input unit 215. Then, a screen listing correction items including sharpness, contrast, and hue relative to the specified area are displayed, and selected by operation of the operation input unit, then a correction item parameter input screen is displayed, and the correction parameter can be set in this screen.

In the extraction region setting screen, the object region of the read photographic image data is displayed on the display 213, and a region among these is set as the extraction region by the user specifying the region by operating the operation input unit 215. Next, after specifying the extraction region, the same correction parameter setting screen is displayed for the specified extraction region, and the correction parameter is set for this extraction region.

Image correction is automatically executed in accordance with the correction parameters set as described above.

In the second embodiment, since the image processing system 2 is provided with a digital camera 1B as a digital image sensing device, and the memory card read/write unit 217 and communication I/F 211 is provided as means for reading an image file and specific information file from the specific recording object of the memory card 100, and the computer 200 is provided as an image processor having a CPU 201 as a correction means for performing image correction of captured image data based on the object name and object region of the specific information file, the computer 200 can perform image correction on the object region of the image data captured by the digital camera 1B without the user specifying the object or object region, thereby simplifying operation.

Since the computer 200 function as an image processor is provided with a hard disk 203 as a template memory means for storing templates, and a memory card read/write unit 217 and communication I/F 211 as reading means for reading an image file and specific information file from the memory card 100 function as a specific recording object, and is further provided with a CPU 201 as a template combining means for reading a template from the hard disk 203 and combining the template with the image data based on the object name and object region of the specific information file, the computer 200 can executed template combination on the object region of the image data captured by the digital camera 1B without the user specifying the object or the object region, thereby simplifying operation.

3. Modifications

In the aforesaid embodiments, the digital image sensing device, and the image processing system, image processing device, digital imaging method, and recording medium provided with same have been described by way of examples, but the present invention is not limited to these examples.

For example, in the above embodiments, frame selection input is accomplished by selecting from a list of key words, but frame selection may be accomplished by selecting from a list of icons representing each main object.

In the digital cameras of the aforesaid embodiments, the image file and specific information file are mutually linked and stored in the memory card 100, but they also may be stored on the flash ROM 41 as a specific recording object.

In the aforesaid embodiments, the object name and object region corresponding to the key word are sought from the frame table, and these data are associated with the image file as a specific information file and recorded as such, but a key word alone may be recorded in the specific information file, and the object name and object region corresponding to the key word may be sought by referencing the frame table during image correction processing and template combination processing.

In the aforesaid embodiments, only image correction processing is performed during shooting, but template combination also may be performed during shooting.

Furthermore, the standard correction parameters for the entire image are automatically initialized in the aforesaid embodiments, but this initialization also may be set by a user using the operation input unit via a correction parameter setting screen for the entire image.

According to the embodiments as described above, since a frame is selected from among a plurality of frames as a selection frame, and the selection frame and a monitor image of a candidate image are superimposed and displayed, the image data of the monitor image are obtained, and the specific information being information for specifying an ideal object region in the selected frame and the type of photographic object corresponding to the selected frame and the aforesaid image data are associated and recorded as a specific recording medium, a main object and object region can be specified in the image data by reading the recorded image data and specific information to easily accomplish image processing. Operation is simplified since the user is not required to specify the main object and object region separately from the frame selection, operation, and manufacturing cost is controlled to provide an inexpensive device because a special designation means is not required to specify the object and object region.

Furthermore, since the frame selection means accomplishes frame selection by selecting a key word from among key words corresponding to a plurality of frames, a plurality of frames can be easily managed by key words, and a desired frame can be easily selected.

Since an object name and object region coordinates and image data are mutually associated and recorded as a specific recording object, the object name and object region coordinates corresponding to the image data can be read without being specified by a user when the image data are read for image processing after having been recorded, thereby simplifying operation.

Since a correction means is provided for correcting photographic image data while referring to the specific information, an object region may be corrected without a user specifying the object and object region within the image data, thereby simplifying the correction operation.

Since template combining means is provided for reading a template from a template memory and combining the template with image data while referencing the specific information, template combination may be accomplished without a user specifying the photographic object and object region within the image data, thereby simplifying the template combination operation.

Since a digital image sensing device, reading means for reading image data and specific information from a specific recording object, and computer having a correction means for correcting image data based on the specific information are provided, the computer can correct an object region of the image data photographed by the digital camera without a user specifying the photographic object and object region within the image data, thereby simplifying operation.

Since a digital imaging device, template memory means for storing templates, reading means for reading image data and specific information from a specific recording object, and computer having a template combination means for reading a template from the template memory means and combining the template with the image data based on the specific information are provided, the computer can accomplish template combination of an object region of the image data photographed by the digital camera without a user specifying the photographic object and object region within the image data, thereby simplifying operation.

Since a reading means for reading image data from a digital imaging device connected to a removably loaded recording medium to allow communication, and specific information being information specifying a photographic object in photographic image data and an object region in the photographed image, and a correction means for correcting image data based on the specific information are provided, an object region of image data read from the digital imaging device or the recording medium can be corrected without a user specifying the photographic object and object region within the image data, thereby simplifying operation.

Since a reading means for reading image data from a digital imaging device connected to a removably loaded recording medium to allow communication, and specific information being information specifying a photographic object in photographic image data and an object region in the photographed image, and a template combination means for reading a template from the template memory means and combining the template with the image data based on the specific information are provided, template combination can be accomplished with regard to image data read from the digital imaging device or recording medium without a user specifying the photographic object and object region within the image data, thereby simplifying operation.

Obviously, many modifications and variation of the present invention are possible in light of the above teachings. It is therefore to be understood that within the scope of the appended claims, the invention may be practiced other than as specifically described.

What is claimed is:

1. A digital imaging device for obtaining image data as digital data of a photographic image including an object, comprising:
a memory for storing image data of a plurality of frames representing an ideal region of an object within an image, each frames corresponding to types of object;
a frame selector for selecting a frame from the plurality of frames as a selected frame;
a display device for displaying the selected frame superimposed on a monitor image obtained by an image sensing device;
an image capture device for capturing a image data based on the monitor image; and
a recording device for recording an information, having a type of the object corresponding to the selected frame and data representing an object area corresponding to the selected frame, and the image data captured by the image capture device on a recording medium being associated each other.

2. The digital imaging device as claimed in claim 1,
wherein the frame selector selects a frame by selecting a key word from a plurality of key words corresponding to each frames.

3. The digital imaging device as claimed in claim 1,
wherein the information has object region coordinates data for specifying the object region and an object name for specifying the type of object.

4. The digital imaging device as claimed in claim 1,
further comprising an image corrector for correcting the image data based on the information.

5. The digital imaging device as claimed in claim 1,
further comprising a template memory for storing a template which is a previously prepared image, and
a template combining means for combining the template from the template memory with the image data based on the information.

6. An image processing system having the digital imaging device as claimed in claim 1,
further comprises a computer having a reading device for reading the information and the image data from the recording medium, and a image corrector for correcting image data based on the information.

7. An image processing system having the digital imaging device as claimed in claim 1,
further comprises a computer having a template memory for storing a template which is a previously prepared image, a reading device for reading the information and the image data from a the recording medium, and a template combining means for combining the template from the template memory with the image gate based on the information.

8. An image processing device for image processing of an image data including an photographic object, comprising:
a reading device for reading the image data and an information having a kind of an object in the image data and an object area data in which the object is arranged within the image data; and
a photographic image corrector for correcting the image data based on the information.

9. The image processing device as claimed in claim 8,
wherein the reading device the image data and the information from a removable recording medium or a digital imaging device through a communication.

10. An image processing device for image processing of an image data including a photographic object, comprising:
a template memory for storing a template which is a previously prepared image data;
a reading device for reading the image data and an information having a kind of an object in the image data and an object area data in which the object is arranged within the image data; and
a template combining means for combining the template from the template memory with the image gate based on the information.

11. The image processing device as claimed in claim 10,
wherein the reading device the image data and the information from a removable recording medium or a digital imaging device through a communication.

12. A digital imaging method for obtaining photographic image data including a photographic object, the method comprising steps of:
selecting a frame from a plurality of frames as a selected frame representing an ideal region of an object within an image, each frames corresponding to types of object;
displaying the selected frame superimposed on a monitor image on a display device;
capturing an image data based on the monitor image displayed on the display device; and
recording an information, comprising a type of the object corresponding to the selected frame and data representing an object area corresponding to the selected frame, and the image data on a recording medium being associated each other.

13. An image processing program for obtaining photographic image data including a photographic object capable of being executed by a digital imaging device, the program comprising following steps of:
selecting a frame from a plurality of frames as a selected frame representing an ideal region of an object within an image, each frames corresponding to types of object;
displaying the selected frame superimposed on a monitor image on a display device;
capturing an image data based on the monitor image displayed on the display device; and
recording an information, comprising a type of the object corresponding to the selected frame and data representing an object area corresponding to the selected frame, and the image data on a recording medium being associated each other.

14. An image processing program for processing of an image data including an photographic object capable of being executed by a computer, the program comprising following steps of:
reading the image data and an information having a kind of an object in the image data and an object area data in which the object is arranged within the image data; and
correcting the image data based on the information.

15. An image processing program for processing of an image data including an photographic object capable of being executed by a computer, the program comprising following steps of:
reading the image data and an information having a kind of an object in the image data and an object area data in which the object is arranged within the image data; and
combining a template read from a template memory with the image data based on the information.
